(19) United States
(12) Patent Application Publication
(10) Pub. No.: US 2020/0178707 A1
(43) Pub. Date: Jun. 11, 2020

(54) PICTURE HOLDER

(71) Applicant: Stacey ALEXANDER, (US)

(72) Inventors: Stacey ALEXANDER, Bloomfield Hills, MI (US); Diane WOOLDRIDGE, Eugene, OR (US)

(73) Assignee: Stacey ALEXANDER, Bloomfield Hills, MI (US)

(21) Appl. No.: 16/710,689

(22) Filed: Dec. 11, 2019

Related U.S. Application Data
(60) Provisional application No. 62/778,183, filed on Dec. 11, 2018.

(51) Int. Cl. A47G 1/06; G09F 1/10

(52) U.S. Cl. CPC A47G 1/0627; G09F 1/10; A47G 1/0638

(57) ABSTRACT

A picture or card holder is provided having a flexible rim defining a picture opening inside an outer retention flap. The flexible rim retains the picture or card without any covering that covers the entire picture or and only covers an edge of the picture or card. A decorative extension is secured to an outer circumference of the rim and extends away from the rim. The picture or card can be removed and exchanged without removing any components of the picture or card holder.

### CROSS-REFERENCE TO RELATED APPLICATIONS

This application claims the benefit of U.S. provisional application Ser. No. 62/778,183 filed Dec. 11, 2018, the disclosure of which is hereby incorporated in its entirety by reference herein.

### TECHNICAL FIELD

This application relates to picture holders and method of making a picture holder.

### BACKGROUND

Picture holders for displaying photographs or cards with messages allow the home or office space to be personalized. One example is U.S. Pat. No. 5,255,457.

### SUMMARY

According to one embodiment, a picture or card holder 10 is provided having a flexible rim defining a picture opening inside an outer retention flap. The outer circumference of the rim is secured to a decorative extension that extends from the rim. The decorative extension may be a plurality of petals extending radially from the rim to define a flower shaped picture or card holder 10. The rim retains the picture or card without any covering, such as clear plastic, that covers the entire picture in order to retain the picture or card. The rim provides secure retention of the picture or card while only covering the outer edge of the picture or card. The picture or card can be easily removed and exchanged for a different picture.

### BRIEF DESCRIPTION OF THE DRAWINGS

FIG. 1 illustrates a perspective view of a picture or card holder 10 according to one embodiment.

FIG. 2 illustrates a perspective view of the picture or card holder FIG. 1 showing the flexible stem in an alternative configuration.

FIG. 3 illustrates a front perspective view of the picture or card holder of FIG. 1.

FIG. 4 illustrates a rear perspective view of the picture or card holder of FIG. 1.

FIG. 5 illustrates a right-side perspective view of the picture or card holder of FIG. 1.

FIG. 6 illustrates a left-side view of the picture or card holder of FIG. 1.

FIG. 7 illustrates a top perspective view of the picture or card holder of FIG. 1.

FIGS. 8-9 illustrate the patterns used to form the components of the picture or card holder of FIG. 1.

FIG. 10-13 illustrates a method of forming the picture or card holder of FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

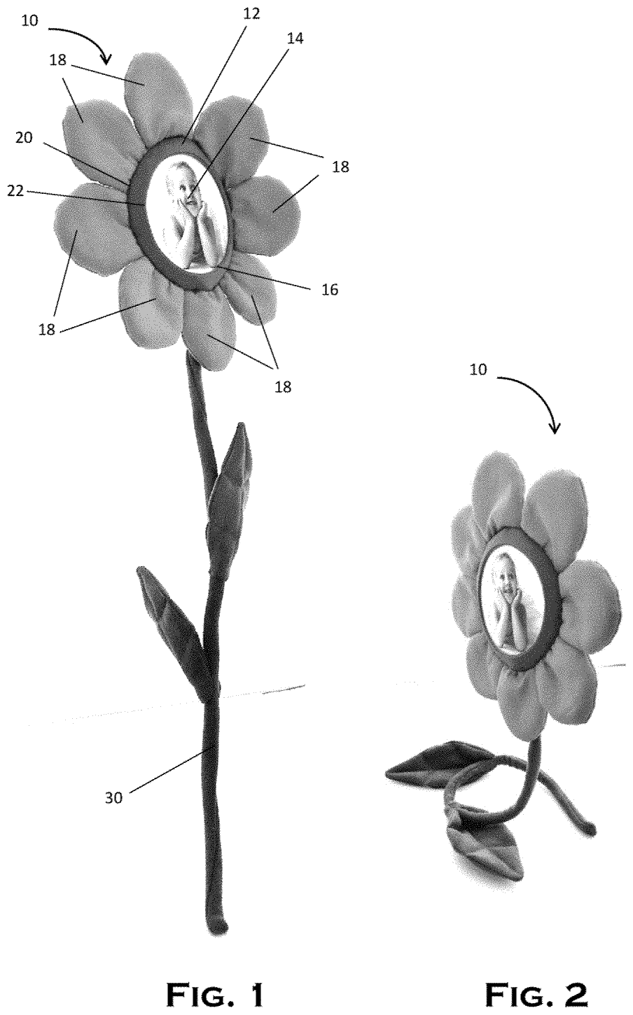

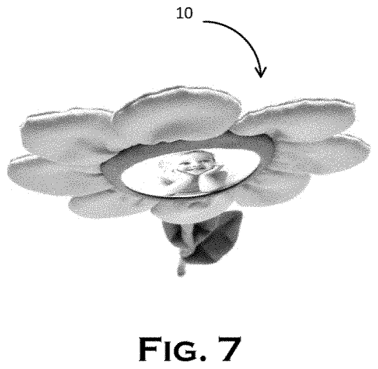

As shown in FIGS. 1-7 show the picture or card holder 10 has a flexible rim 12 defining a picture opening 14 inside an outer retention flap 16. A decorative extension 18 extends from the outer edge 20 of the flexible rim. An inner circumference 22 of the flexible rim 12 defines the picture opening 14 and can bend to allow the card or picture to be inserted. As illustrated in the figures, the decorative extension 18 is formed as a flower having a plurality of petals that extends radially from the rim to define the flower.

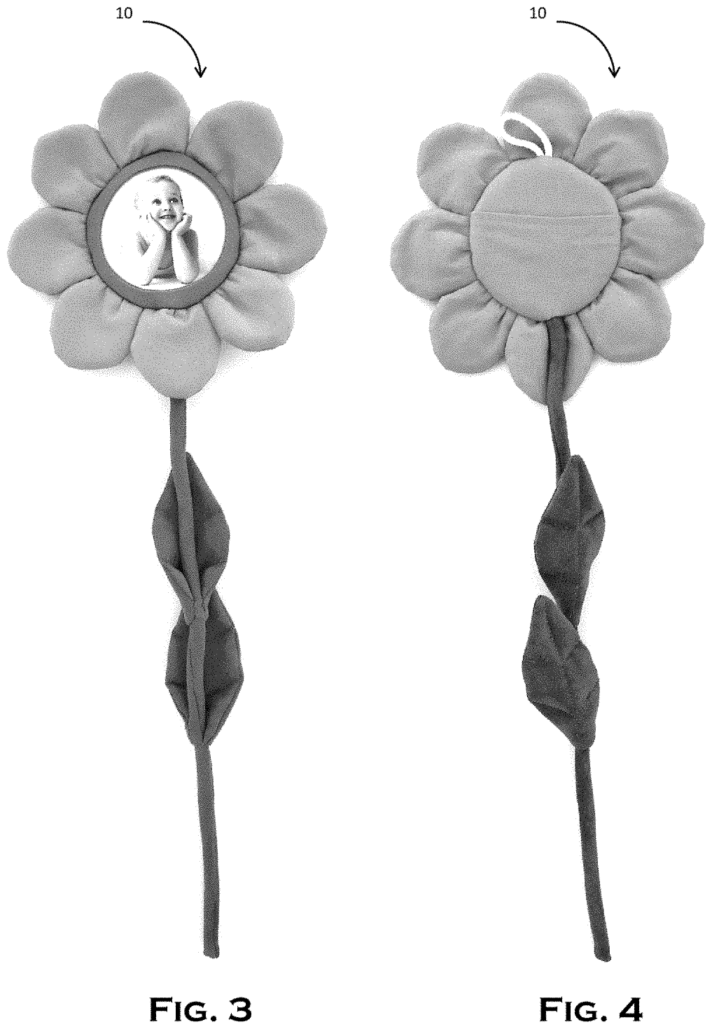

The picture or card holder 10 may also include support member 30. As shown in the figures, the support member 30 may be shaped as a stem 30 may be flexible. For example, FIG. 2 illustrates the flexible stem in an alternative configuration.

The decorative extension 18 may have various shapes or themes that extend from the outer edge of the rim. For example, the decorative extension 18 may be shaped like an animal, such as a Dog, Cat, Lion, Elephant, Giraffe, Bird, Horse, Monkey, Cow, Deer, Duck or other animal shape that extends from the outer edge of the rim. The decorative extension 18 may be shaped as a Plane, Train, Car, Boat, Bike, or other transportation-themed shapes. The decorative extension 18 may be shaped as a Baseball, Football, Soccer ball, Hockey puck/skate, Basketball, Golf ball/club, Volleyball, Tennis ball/racket, Boxing glove, Track shoe or other sports-themed shapes. The decorative extension 18 may be shaped as a Cross or Star of David, or other religious-themed shape. The decorative extension 18 may be shaped as a Christmas tree, Thanksgiving turkey, Chanukah dreidel, Valentines heart, St. Patrick's Day clover, New Years noise-maker, Easter egg, Halloween pumpkin, or other holiday-themed shapes. The decorative extension 18 may be shaped as a Wedding bell, Bar/Bat Mitzvah Torah, Baby Shower rattle, Birthday balloon, Graduation diploma, or other special occasion-themed shapes. The decorative extension 18 may have a profession-themed shape such as a tooth/brush (Dentist), apple/pencil (Teacher) or other suitable shapes. The decorative extension 18 may also be formed as company logos or stylized trade/service marks.

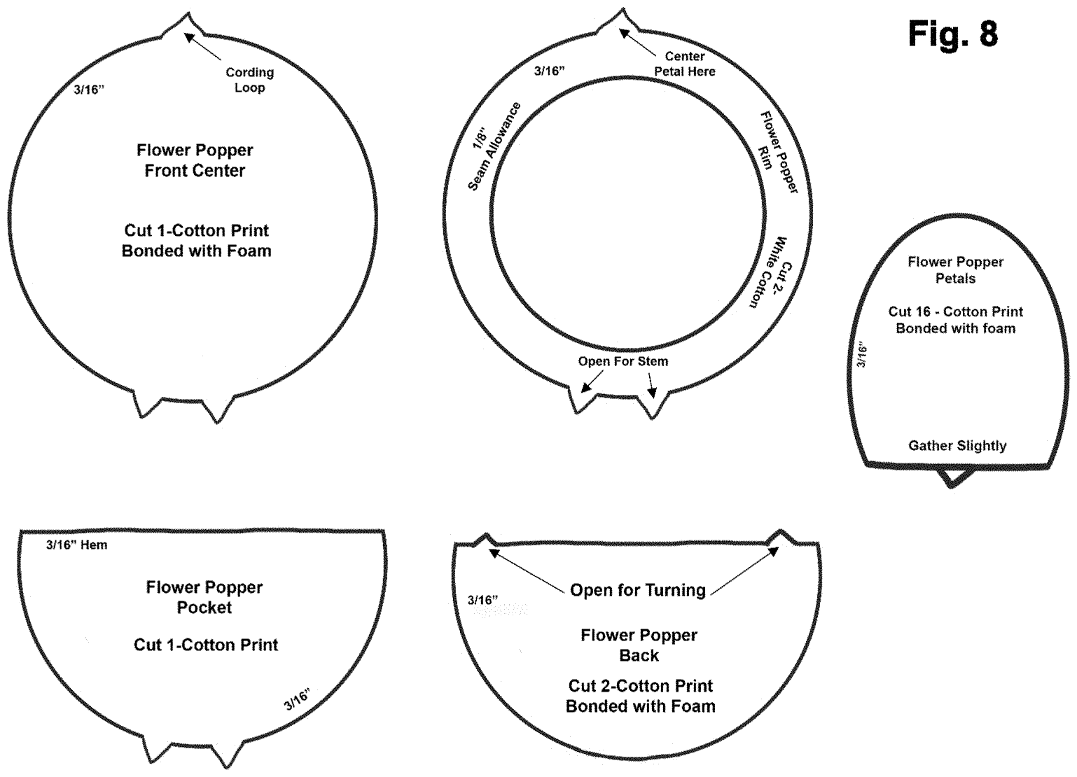

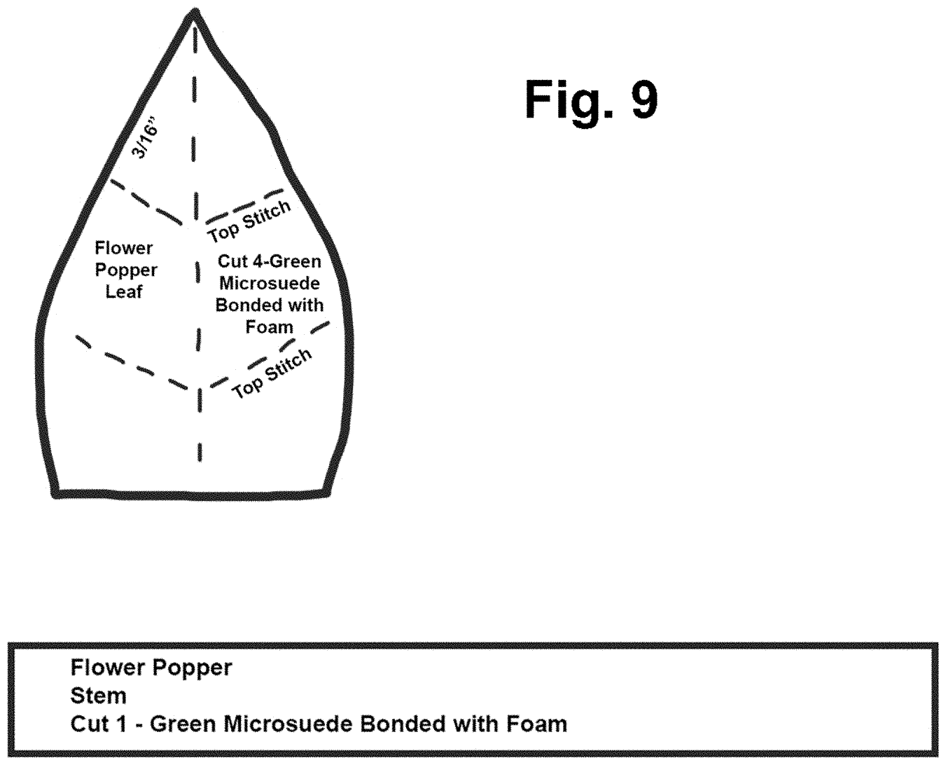

FIG. 8 and FIG. 9 illustrate the patterns used to form the components of the picture or card holder 10 of FIG. 1. As shown in FIGS. 8 and 9, the picture or card holder 10 has seven pattern pieces. The pattern pieces include a front center piece, the rim piece, a pocket piece, a back piece, a petal piece, a stem piece and a leaf piece.

As indicated on the pattern pieces in FIGS. 8-9 the front center piece may be cut from a cotton print fabric, however, it may be formed of any suitable fabric material and may be solid or have a print design. The front center piece may be bonded with foam. The final picture or card holder 10 includes one front center piece.

The rim piece may be cut from white cotton fabric, however, it may be formed of any suitable fabric material and may be solid or have a print design. The final picture or card holder 10 includes two rim pieces.

The pocket piece may be cut from cotton print fabric, however, it may be formed of any suitable fabric material and may be solid or have a print design. The pocket piece may be bonded with foam.

The back piece may be cut from cotton print fabric, however, it may be formed of any suitable fabric material and may be solid or have a print design. The back piece may be bonded with foam. The final picture or card holder 10 includes two back pieces.

The decorative extension 18 to define the flower is formed a petal piece, as shown and illustrated. However, the decorative extension 18 may have any suitable shape, as discussed above. The decorative extension 18 may be cut from cotton print fabric, however, it may be formed of any suitable fabric material and may be solid or have a print design. The decorative extension 18 may be bonded with foam. As shown, the final picture or card holder 10 includes sixteen petal pieces to form eight petals. However, the number of petal pieces may vary based on the number of petals. Further, the petal piece dimensions and shape may also vary. For example, the petal piece may be more elongated or more angular than the generally rounded petals shape illustrated in FIG. 8. Any shape or number of petals is contemplated.

The leaf piece may be cut from micro-suede fabric, however, it may be formed of any suitable fabric material and may be solid or have a print design. The leaf piece may be bonded with foam and may be top stitched. As indicated, the final picture or card holder 10 includes four leaf pieces to form two leaves. However, the number of leaf pieces may vary based on the number of leaves. Further, the leaf piece dimensions and shape may also vary and any shape or number of leaves is contemplated.

The stem may be formed of flexible coated aluminum wire. However, any suitable material may be used to form the stem. The stem may be approximately twenty-seven inches in length. However, the stem may be any desired length. The wire may be covered with micro-suede material bonded with foam, however any suitable foam material may be used. In the embodiment illustrated in FIGS. 1-7, one leaf is stitched to the stem approximately five inches from the bottom of the stem and the other leaf is stitched to the stem eight inches from the bottom.

As discussed with regard to each pattern piece, the fabrics are not limited to the fabrics shown or described, and any suitable fabric may be used in forming the pattern pieces. Additionally, the color, print, texture, or other material characteristics may be varied.

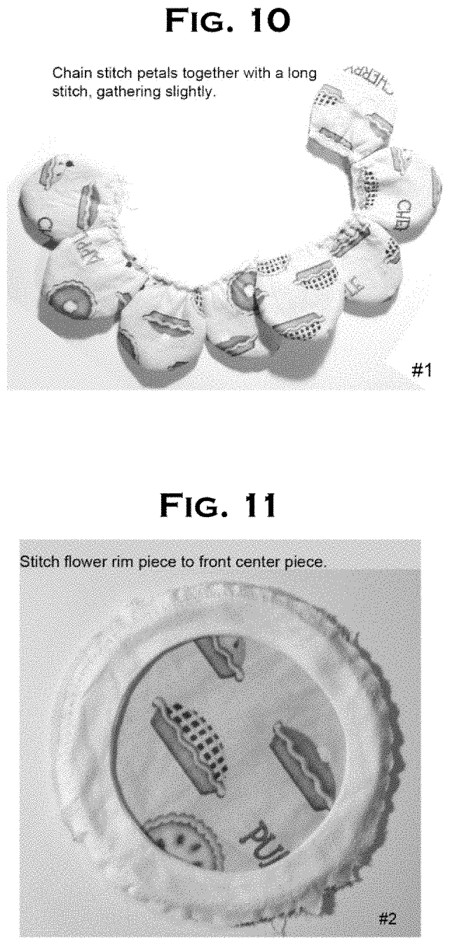

FIG. 10-15 illustrates a method of forming the picture or card holder 10 of FIG. 1. First, the appearance sides of two petal pieces are placed together and stitched together to form each petal. Then each petal is turned right side out so the appearance sides are visible and the seam is concealed. As shown in FIG. 10, the petals are chain stitched together with a long stitch. The thread may be pulled up slightly to gather fabric.

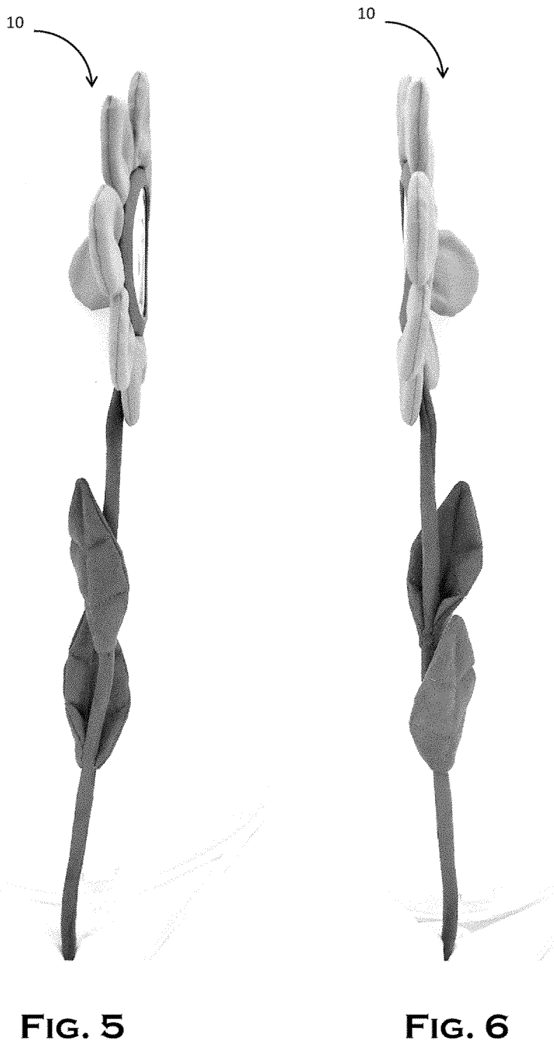

The back pieces are stitched together, leaving an opening between notches in the back pieces. The pocket piece is hemmed along the straight edge. A hanging loop, shown in FIG. 4, may be stitched to the top center of the back piece. The pocket piece is stitched to the back piece.

The appearance sides of the rim pieces are placed together and stitched together along the inner circumference. Then the rim is turned right side out. The assembled rim is then stitched to the front center piece, as shown in FIG. 11.

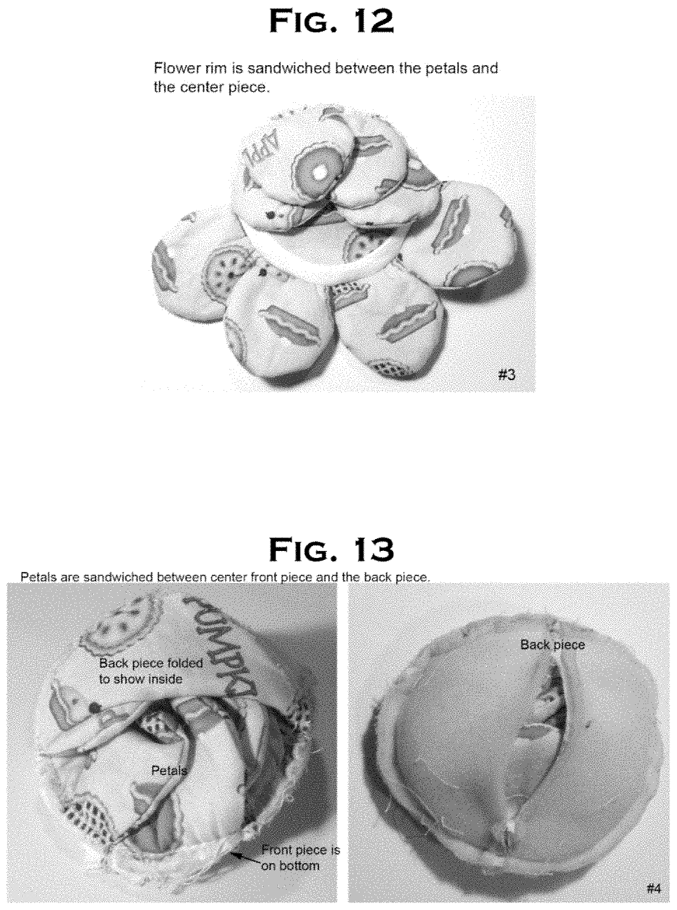

The petals are then assembled to the rim and front center piece. The appearance sides of the petals are arranged on top of the front center piece as shown in FIG. 12. The rim is sandwiched between the petals and the center piece.

With appearance sides together, the back piece is placed on top of the front center piece. The petals are sandwiched between center front piece and the back piece, as shown in FIG. 13. The back piece, rim and front piece are stitched together, leaving an opening between the bottom notches for the stem.

Finally, the assembled flower is turned right side out, as shown in FIG. 1-7. In the completed flower assembly, the rim is forward of the front center piece and the petals. The rim extends inward from the petals and from the periphery of the front center piece. The rim is attached along the outer circumference of the front center piece and not attached along the inner circumference to define a flexible retention flap. As such, a picture or card can be retained by the rim between the inner circumference and outer circumference allowing the picture to be visible in the area inside the inner circumference. The rim retains the picture or card without any covering, such as clear plastic, that covers the entire picture in order to retain the picture or card. The rim provides secure retention of the picture or card while only covering the outer edge of the picture or card. The picture or card can be easily removed and exchanged for a different picture without removing any components of the picture or card holder 10.

As shown in the Figures, the outer circumference 20 and inner opening 22 of the rim 12 may be circular. However, other shapes are contemplated. For example, the outer circumference 20 of the rim 12 may be oblong, oval, square or other suitable shapes. The inner opening 22 of the rim 12 may be concentric with the outer circumference 20. However, the rim 12 my have a varying thickness so the inner or the inner opening my not be centered on the outer circumference. The inner opening 22 may also have a different shape than the outer circumference 20.

The stem may be added to the flower. The stem piece is folded lengthwise with appearance sides together and stitched together leaving an opening in the center for turning. Turn stem right side out. Fold in seam allowance on one end and hand stitch closed. Hand stitch opening in center stem. The wire is inserted into the fabric stem. Fold in bottom seam allowance of leaves and stitch closed. The leaves are wrapped and stitched around the sides of the stem. The wire end of the stem is inserted into bottom opening in flower, curving the wire in a circular shape inside the center flower. The stem is stitched into the flower front and back.

The method describes stitching of the pattern pieces, however any suitable attachment method may be used, such as adhesive, thermal bonding or other suitable methods for joining the materials.

The picture or card holder 10 may be used in various applications. For example, a group of picture or card holders 10 may form a bouquet and supported for display in a vase, for example, with each picture or card holder 10 having a different photograph or card. The picture or card holder 10 may be hung using the loop for hanging. The picture or card holder 10 may be displayed with the flexible stem wrapped around an object.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A picture or card holder comprising:
a flexible rim defining a picture opening inside an outer retention flap, wherein the flexible rim retains the picture or card without any covering that covers the entire picture or and only covers an edge of the picture or card; and
a decorative extension secured to an outer circumference of the rim and extends away from the rim,
wherein the picture or card can be removed and exchanged without removing any components of the picture or card holder.

2. The picture or card holder of claim 1, wherein the decorative extension comprises a plurality of petals extending radially from the rim to define a flower shaped picture or card holder.

3. The picture or card holder of claim 1, wherein the flexible rim is formed of fabric material.
